(19) United States
(12) Patent Application Publication
(10) Pub. No.: US 2014/0316594 A1
(43) Pub. Date: Oct. 23, 2014

(54) SYSTEMS, DEVICES, AND METHODS FOR REDUCING SAFETY RISK AND OPTIMIZING ENERGY USE

(71) Applicant: Green Edge Technologies, Inc., Poway, CA (US)

(72) Inventors: Scott A. STEELE, Poway, CA (US); Norma JURGENS, Rhinelander, WI (US); William P. ALBERTH, JR., Prairie Grove, IL (US); David K. HARTSFIELD, Poway, CA (US)

(21) Appl. No.: 13/864,904

(22) Filed: Apr. 17, 2013

(51) Int. Cl. G05B 9/02

(52) U.S. Cl. CPC G05B 9/02
USPC 700/291; 700/292

(57) ABSTRACT

The present disclosure is generally directed to reducing a safety risk in an automation system such as an automated electrical system in a structure such as a residential, commercial, or industrial building. More particularly, the present disclosure includes systems, devices, and methods for intelligently monitoring and controlling conditions in components and/or wired connections of an automation system indicative of a potential fire hazard.

### DESCRIPTION OF THE INVENTION

1. Field of the Invention

Embodiments of the present disclosure are directed to systems, devices, and methods for automating the detection of abnormal energy use to identify and resolve potentially unsafe conditions, and to optimize energy use. More particularly, the present disclosure includes methods of detecting a flow of power that may indicate an unsafe condition, e.g., a fire hazard.

2. Background of the Invention

Safety remains a concern for home and business owners, managers, and operators. The ability to detect a catastrophic failure of an electrically powered device, or a device using a combustible fuel. such as natural gas or liquid propane gas (LPG) early has the potential to reduce damage caused by the failure. Further, failure may result from deterioration of a device over time, leading to increased safety risk and inefficient energy use.

U.S. Patent Application Publication No. 2010/0188229, entitled SAFETY SHUT OFF SYSTEM FOR HOUSE-HOLD APPLIANCES, teaches a method of determining if a motion has occurred in an area, and if not, shutting off a device. If a homeowner has an oven on and leaves home, for example, the lack of motion could he detected and used to shut off the oven. This may possibly prevent a fire, but it may also prevent a turkey dinner from cooking to completion if the oven is turned off, e.g., because the homeowner was in a different part of the house than the kitchen.

U.S. Patent Application Publication No. 2002/0149891, entitled ARC FAULT DETECTOR WITH CIRCUIT INTERRUPTER, discusses combining arc detectors with appliance leakage circuit interrupters, of which one type is sometimes known as GFCI or ground fault circuit interrupters. These devices attempt to detect arcing or other abnormal power conditions which may indicate a potentially unsafe situation, and then shut off power to the circuit. These devices may detect when a catastrophic failure has already occurred and attempt to shut off power before significant damage or harm occurs.

What is needed is a method to determine when an appliance is in need of maintenance, e.g., due to deterioration or degradation in performance, and identify the situation so that preventive action can be taken to prevent significant safety risk and/or catastrophic failure. Further needed is a method to detect When a failure may be imminent and to take automatic action to prevent an expensive or harmful failure.

### SUMMARY OF THE INVENTION

The present disclosure is generally directed toward detecting one or more operating characteristics of a device that is consuming energy, monitoring the characteristic over time, and initiating a response if the characteristic exceeds a limit. If the characteristic exceeds a first limit, for example, maintenance may be requested or scheduled for the device, automatically or manually. If the characteristic exceeds a second limit, for example, the device may be deactivated to prevent a catastrophic failure.

In one embodiment, the present disclosure includes a method of determining a class of an appliance plugged into or otherwise coupled to an outlet. The profile of power expected to be drawn by the appliance may be determined, and if the appliance exceeds a first threshold the appliance may be flagged for maintenance. Further, for example, if the appliance draws power that exceeds a second threshold, the appliance may be considered defective and shut down. That is, power delivery to the appliance may be temporarily or permanently interrupted.

In another exemplary embodiment, a home automation system may determine which devices share a circuit. If a circuit is drawing more than a predetermined threshold, for example, or if one or more components of the circuit are overheating, then the one or more components, some of the components, or all of the components identified on the circuit may be deactivated to reduce the load on the circuit.

Embodiments of the present disclosure are further directed to systems, devices, and methods for intelligently controlling and/or tracking one or more energy consuming devices in a structure, including, but not limited to, a home, office, hospital, sporting complex, or school, and may include methods of identifying devices that have a high priority. Devices identified as a high priority may be preferentially granted access to electrical power, and may be excluded from any power interruption.

While the embodiments often use electric power as an example, the methods disclosed herein are also applicable to other utilities and resources such as, e.g., steam, water natural gas, liquid propane gas (LPG), and/or other utilities. Indeed, the principles described herein may be used in connection with any utility or resource that may be consumed by a user.

Various embodiments of automation systems disclosed may include one or more of the following features: an outlet including an adaptor configured to be operably coupled with a preexisting electrical outlet; at least one sensor, e.g., a plurality of sensors; the at least one sensor may include one of a motion sensor, light sensor, and a temperature sensor; the outlet may include a microprocessor; one of the control unit and microprocessor may be configured to receive power consumption data for one or more electrical devices from a power monitor; one of the control unit and microprocessor may be configured to compare the received power consumption data to power consumption data of known electrical devices; one of the control unit and microprocessor may be configured to identify the one or more electrical devices based on the comparison of the received power consumption data. to power consumption data of known electrical devices; the at least one outlet may be configured to detect an electrical noise in a power line generated by the one or more electrical devices; the at least one outlet may be configured to communicate the detected electrical noise to the control unit; the control unit may be configured to compare the detected electrical noise to electrical noise data of known electrical devices; the control unit may be configured to identify the one or more electrical devices based on the comparison of the detected electrical noise to electrical noise data of known electrical devices; the sensor may be configured to detect a radiofrequency signal; a switch operably coupled to the controller and the outlet; the control unit may be configured to communicate with the Internet; the communication link may be configured to allow wireless communication between the outlet and the control unit; and the control unit may be configured to terminate delivery of electrical energy to the at least one outlet based on an input from the at least one sensor.

The present disclosure includes a method of controlling power to a device, the method comprising measuring at least one power consumption characteristic of the device; determining an identity of the device; comparing the at least one power consumption characteristic measured to an energy profile of the device, wherein the energy profile includes at least one operating limit and a known power consumption characteristic associated with the identity of the device; and controlling power to the device based on the comparison, Embodiments of the present disclosure may include one or more of the following features: the identity may include a type or model of the device; the at least one operating limit may be a function of time, an age of the device, an environmental condition to which the device is exposed, a frequency of operation of the device,. or a combination thereof; the energy profile may include at least two limits corresponding to different operating modes of the device; the method may comprise providing information on the status of the device based on comparison of the at least one power consumption characteristic measured and the at least one operating limit, wherein the information is stored, transmitted, displayed, or a combination thereof; the information may include at least one of a warning, an alarm, or a recommendation to perform maintenance on the device; the information may be transmitted to a mobile device; the method may comprise optimizing an energy use of the device based on the information; controlling power to the device may include interrupting a supply of power to the device if the at least one power consumption characteristic measured exceeds the at least one operating limit; the at least one operating limit may include a first operating limit and a second operating limit; controlling power to the device may include interrupting a supply of power to the device if the at least one power consumption characteristic measured exceeds the second operating limit; the method may comprise providing information on the status of the device if the at least one power consumption characteristic measured exceeds the first operating limit, the second operating limit, or both; the method may comprise replacing the device if the at least one power consumption characteristic measured exceeds the first operating limit but not the second operating limit; replacing the device may include purchasing a second device; contacting a service provider if the at least one power consumption characteristic measured exceeds the second operating limit; the method may comprise collecting data for the device from at least one sensor, wherein controlling power to the device is also based on the data from the at least one sensor; or the at least one sensor may be a sail switch, a thermostat, or a thermometer.

The present disclosure further includes a method of determining an operating condition of a device, the method comprising measuring at least one power consumption characteristic of the device; determining an identity of the device; comparing the at least one power consumption characteristic measured to an energy profile of the device, wherein the energy profile includes a first operating limit, a second operating limit, and a known power consumption characteristic associated with the identity; and providing information on the status of the device based on comparison of the at least one power consumption characteristic measured to the energy profile, wherein the information is stored, transmitted, displayed, or a combination thereof. Embodiments of the present disclosure may include one or more of the following features: the information may include at least one of a warning, an alarm, or a recommendation to perform maintenance on the device; or the method may comprise interrupting a supply of power to the device if the at least one power consumption characteristic measured exceeds the second operating limit.

The present disclosure further includes a method of managing safety in an automation system, the method comprising measuring a difference in voltage between power supplied to a component of the system and power received by the component; determining an energy loss associated with the difference in voltage; and controlling power to the component to minimize a safety risk associated with the energy loss. Embodiments of the present disclosure may include one or more of the following features: measuring the difference in voltage may include Measuring a change in voltage at a first outlet and a second outlet when an appliance connected to the first outlet or the second outlet undergoes a change of state; the change of state may include receiving a supply of power; the method may comprise measuring a voltage at a breaker box connected to at least one of the first outlet and the second outlet and determining an energy loss in a circuit connecting the breaker box to the first outlet or the second outlet; the voltage measurements may be repeated to determine the energy loss over time; the energy loss may correspond to heating of a component or wired connection of the system; the energy loss may be measured by an infrared energy sensor; determining whether the first outlet and the second outlet are on a single circuit based on the measured change in voltage; the first outlet and the second outlet may be on a single circuit, a first device may be connected to the first outlet, and a second device may be connected to the second outlet; the method may comprise determining a priority between the first device and the second device; the energy loss may correspond to heating of the circuit; or the method may comprise interrupting power to the first device or the second device based on the priority determination.

It may be understood that both the foregoing general description and the following detailed description are exemplary and explanatory only, and are not restrictive of the disclosure, as claimed. The present invention will be more clearly understood from the detailed description below in conjunction with the accompanying drawings.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIG. 1 schematically illustrates an exemplary automation system, in accordance with an embodiment of the present disclosure.

FIG. 2 schematically illustrates an exemplary switch, in accordance with an embodiment of the present disclosure.

FIG. 3 schematically illustrates an exemplary outlet, in accordance with an embodiment of the present disclosure.

FIG. 4 is a flow diagram of an exemplary method, in accordance with an embodiment of the present disclosure.

FIG. 5 shows a flow diagram to detect excessive heat, in accordance with an embodiment of the present disclosure.

### DETAILED DESCRIPTION

Reference now will be made in detail to embodiments of the present disclosure, examples of which are illustrated in the accompanying drawings. Wherever possible, the same reference numbers will be used throughout the drawings to refer to the same or like parts and/or components.

Overview

An automation system, e.g., a home automation system, generally may include one or more switches and one or more outlets, with the user desiring which outlet or outlets are controlled by the switch(es). Existing X10 devices require the user to manually set an address on the switch and the outlet, an outlet would respond to a switch with an identical address enabling or disabling power to the outlet on command of the identically addressed switch.

Embodiments of the present disclosure include, among other things, an automation system. Examples of suitable systems include those described in U.S. application Ser. No. 13/672,534, filed Nov. 8, 2012, the entire disclosure of which is incorporated by reference herein. Systems according to the present disclosure may be used in, e.g., residential, commercial, and/or industrial structures. Non-limiting examples include single-family and multi-family dwellings, condominium units, apartments, apartment buildings, offices, office buildings, schools, churches, sporting complexes, shopping centers, and manufacturing facilities.

The present disclosure may allow a user to determine the identity of a device plugged into an outlet, determine if the device is operating in an expectant manner, and if not operating correctly, to flag the device for maintenance and/or disable the device.

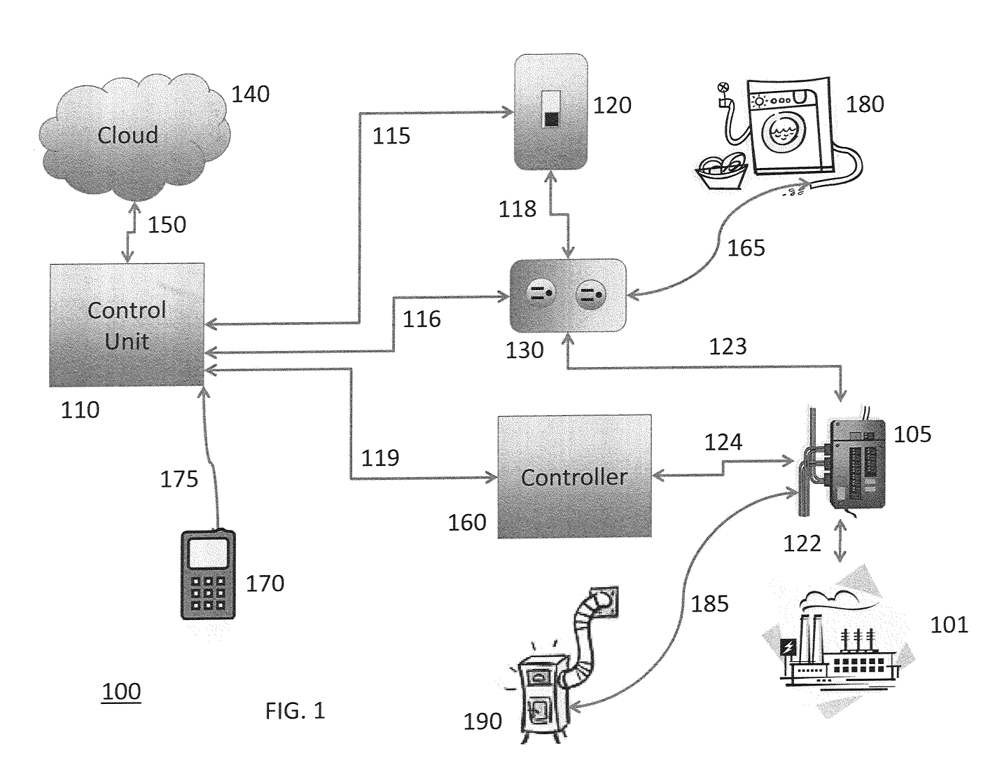

The present disclosure may be further understood with reference to embodiments shown in FIGS. 1-5. In one embodiment shown in FIG. 1, for example, the automation system 100 includes at least one outlet 130, which can be locally or remotely controlled. The outlet 130 may be configured to monitor the power consumed by one or more devices (e.g., appliances) connected thereto and/or control power delivered by the outlet 130. The system 100 further includes a switch 120, which may send a signal (e.g., a wireless signal) to a control unit 110. The control unit 110 may also be locally or remotely controlled and may include, for example, a computer with a microprocessor, memory, and user interface. The control unit 110 may be a discrete control unit, such as, e.g., a laptop, desktop, tablet, or any other suitable device. The control unit 110 may be connected via wired or wireless network connection 150 to the Internet cloud 140. The control unit 110 also may be connected to the switch 120 via wired or wireless connection 115, and further connected to the outlet 130 via wired or wireless connection 116. Similarly, the switch 120 may be connected to the outlet 130 via wired or wireless connection 118.

The system 100 may include one or more other components or enhancements. Referring to FIG. 1, for example, the automation system 100 may include a controller 160 that can control (e.g., adjust, open, close) window coverings. Controller 160 may be also configured to control other systems or enhancements associated with a home, office, school, or other structure. For example, controller 160 may control systems for irrigation, heating and cooling, entertainment, and/or water heating. In addition, controller 160 may control one or more safety systems. In embodiments where controller 160 may control window treatments, the controller 160 may receive instructions from the control unit 110 via wired or wireless connection 119. The switch 120 may also communicate with the controller 160 via wired or wireless means (not shown). The wired or wireless connections, for example 115, 116, 118, and 119, may use the same or different protocols or standards. In addition to instructions being processed by control unit 110, some or all of the processing could be performed by one or more microprocessors included in the switch 120, the Internet cloud 140, or the outlet 130. It is understood that the system 100 may include multiple switches 120, outlets 130, and/or controllers 160, e.g., window control units. Other devices such as moisture sensors maybe attached to the system 100 to provide information on the presence of water or rain. The outlet 130, switch 120, control unit 110, and controller 160 may include one or more features of the outlet, switch, control, and controller, respectively, described in U.S. application Ser. No. 13/672,534, filed Nov. 8, 2012, which is incorporated herein by reference.

A mobile device 170 may be wirelessly connected to the system 100 via wireless connection 175. For example, the mobile device 170 may be connected to the control unit 110 as shown in FIG. 1, or may also be connected to the outlet 130, controller 160, switch 120, another device connected to the automation system 100, or any combinations thereof. The mobile device 170 may include a wireless transceiver, which provides means to measure received signal strength. The mobile device may include any suitable means of collecting, recording, analyzing, and/or transmitting data in order to locate, characterize, and/or otherwise identify devices and components of an automation system. In some embodiments, for example, the mobile device 170 includes an imaging device, e.g., a camera, for taking and transmitting pictures. The mobile device 170 may also include means for determining location and/or orientation information. Non-limiting examples of such technology include GPS, accelerometers, compasses, and gyroscopes. The mobile device 170 may collect data to determine the orientation of the camera when taking a picture, e.g., whether the camera is pointed towards a ceiling, a floor, or a wall. The geographic location and cardinal direction of the camera may also be determined via a compass, GPS, and/or other suitable data collected by the mobile device 170. In addition to instructions being processed by control unit 110, some or all of the processing could be performed by mobile device 170. Suitable methods of collecting and processing such information are described in U.S. application Ser. No. 13/766,123, tiled Feb. 13, 2013, which is incorporated herein by reference in its entirety.

Further referring to FIG. 1, power may be generated at power plant 101, and transmitted to a home meter or breaker box 105 via, for example, wired transmission lines 122. The methods presently disclosed also may be applied to other utilities and/or alternative energy sources such as, e.g., water, natural gas, steam, heat, solar, wind, geothermal, algal, biomass, or any other utility or resource. Power may be routed to the outlet 130 by wires 123, and routed to controller 160 via wires 124. Power further may be routed to a heating ventilation and air conditioning system (HVAC) 190 via wire 185. It is also expected that power could be transmitted wirelessly and one or more of wires 122, 123, and/or 124 could be replaced with wireless transmission Methods. Each set of transmission wires, such as wires 123, may be referred to as a circuit. A circuit may, for example, be connected to and provide power to multiple devices, e.g., via multiple outlets 130. In some embodiments of the present disclosure, the system includes one or more circuits, e.g., circuit 123.

Breaker box 105 may measure voltage, current, and/or power on one or more power lines leading into and out of the breaker box 105. Breaker box 105 may, for example, include a utility meter. Breaker box 105 may be wired. or wirelessly connected. to automation system 100, and may include one or more sensors such as voltage meters, current meters; temperature sensors, or other types of sensors. The sensor(s) may be wired or wirelessly connected to the automation system 100.

An appliance 180 such as, e.g., a washing machine, may be plugged into or otherwise operably coupled to an outlet 130 through connection 165, which may be wired or wireless. The appliance 180 may be able to communicate with system 100 and/or another entity, and the appliance 180 may have the ability to measure the amount of power drawn from outlet 130.

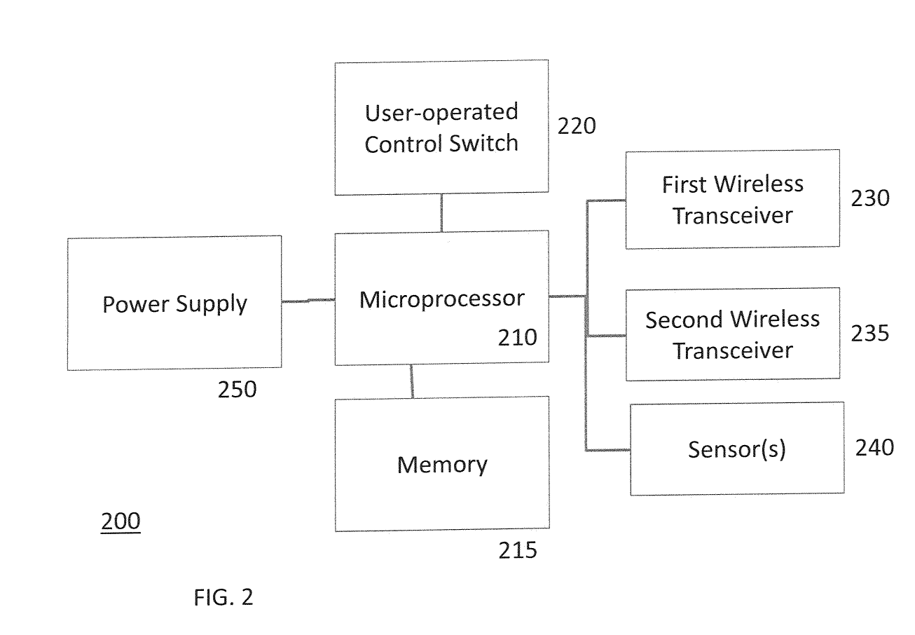

FIG. 2 shows a block diagram for a switch 200 that may be used in the automation system 100 and may operate as the switch 120 in FIG. 1. in at least some embodiments, the switch 200 is remotely controlled. The switch 200 may include a microprocessor 210 capable of running software or an algorithm stored in memory 215. Memory 215 may he, e.g., solid state or flash memory, or any other suitable type of memory. The switch 200 may include a user-operated portion 220, such as a mechanical light switch. In some embodiments, the switch includes one or more user input devices, including, for example, a touch sensor, a touch screen, and/or push buttons. User-operated portion 220 may be configured to control (e.g., interrupt, adjust, change, terminate and/or meter) the supply of energy to a device or an outlet (e.g., outlet 130 shown in FIG. 1) in communication with switch 200. In at least some embodiments, the user-operated portion is configured to control the supply of electrical energy to a device or outlet. Accordingly, in one embodiment, the user-operated control portion 220 may be configured to transition between an “on” position and an “off” position (i.e., supplying and terminating power, respectively). In another embodiment, the switch may allow various levels to be controlled by the user discretely or continuously.

The switch 200 may further include a first wireless transceiver 230, for example a 802.11 Wi-Fi transceiver. The term “transceiver” as used herein should not be construed as limited to any particular structural components. Instead, a transceiver may include any structural components configured to allow for back and forth communication. Accordingly, the transceivers disclosed herein may include, but are not limited to, antennae, power supplies, communication ports, and/or any other elements needed to achieve the desired function. The first wireless transceiver 230 may be configured to communicate over any known protocol including, but not limited to, X10, Zigbee®, and/or Bluetooth. Further, although the exemplary embodiment of FIG. 2 depicts the transceiver 230 as a wireless transceiver, those of ordinary skill will readily recognize that first wireless transceiver 230 may be replaced with a wired communication mode. First wireless transceiver 230 may allow the switch 200 to communicate with a control device, e.g., the control unit 110 as shown in FIG. 1. The first wireless transceiver 230 therefore may allow the switch 200 to exchange commands with the control unit 110 of the automation system 100.

In some embodiments, the switch 200 may also include a second wireless transceiver 235 to allow the switch 200 to communicate with one or more devices (e.g., the outlet 130 shown in FIG. 1 or any electrical load coupled thereto) using multiple standards. Both transceivers 230 and 235 may include received signal-strength indicator means to identify the strength of a signal received by the transceiver. The first and second wireless transceivers 230, 235, respectively, may allow for communication over one or more protocols. In addition, the first wireless transceiver 230 may be configured to communicate over a protocol that is different from the communication protocol of the second wireless transceiver 235.

The switch 200 may include one or more sensors 240 configured to detect and respond to various conditions or stimuli, such as temperature, moisture (e.g., water, rain, or humidity), light, sound, air flow, contaminants, motion, or electromagnetic or radio frequencies. Examples of such sensors are disclosed in U.S. application Ser. No. 13/672,534, which is incorporated herein by reference. The switch 200 may also include a power supply 250, which may be any suitable power supply known in the art. In some embodiments, for example, the power supply 250 includes a battery, e.g., a rechargeable battery. It is understood that the power supply 250 in FIG. 2 may schematically illustrate a wired or wireless connection to a power network, such as, e.g., a power grid or transformer. Further, the power supply 250 may include both a battery and a connection to a power network.

The switch 200 may include a microprocessor 210, which may be any suitable microprocessor known in the art. Although FIG. 2 shows the microprocessor 210 located within the switch 200, the microprocessor 210 may also be remotely connected to the switch 200. The microprocessor 210 may be configured to communicate, e.g., exchange control signals, with the one or more sensors 240, the first wireless transceiver 230, the second wireless transceiver 235, and/or the user-operated portion 220.

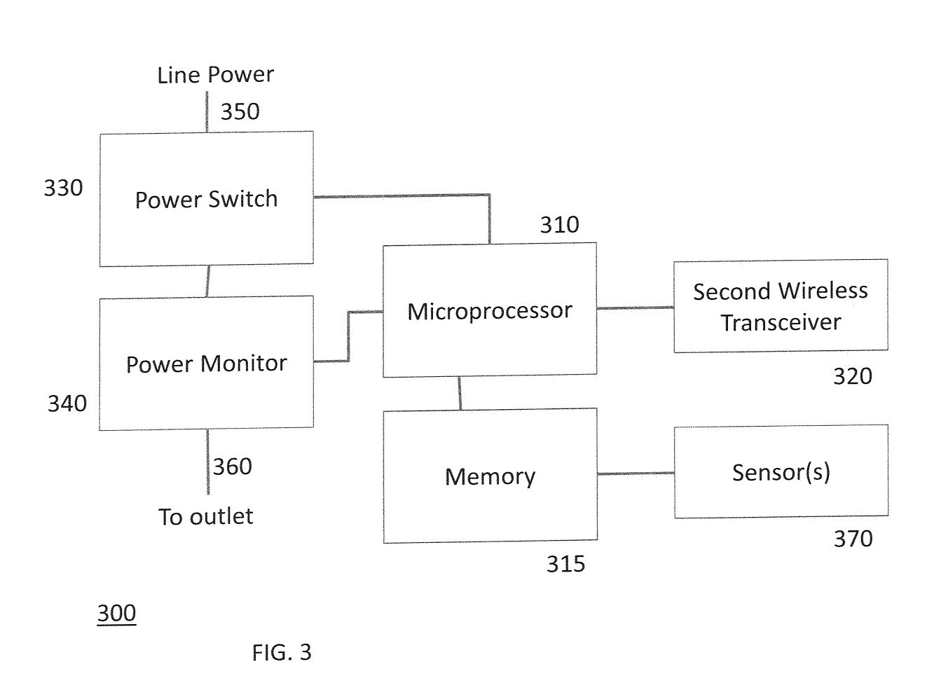

FIG. 3 shows a block diagram of an outlet 300 that May operate as the outlet 130 of the system 100 shown in FIG. 1. In at least some embodiments, the outlet 300 is remotely controlled. The outlet 300 may include a microprocessor 310 that runs software or an algorithm stored in memory 315. The microprocessor may be remote. The outlet 300 further may include a transceiver 320, which may include any of the features described in connection with transceivers 230 and 235 of FIG. 2. The outlet 300 also may include one or more sensors 370, which can include, e.g., motion sensors, voltage sensors, current meters, ambient light sensors, cameras, microphones, moisture sensors, or any of the sensors described above with respect to the one or more sensors 240 of FIG. 2. The sensors may allow at least one of the voltage and current to be measured at connection 350.

In some embodiments, the outlet 300 receives electrical energy via a power switch 330 supplied by line power via connection 350. The power switch 330 may be controlled by a microprocessor, e.g., 310, which may include any or the features described with respect to the microprocessor 210 of FIG. 2. The power switch 330 may be configured to correct or disconnect the line power to the outlet 300, including a connected load 360 (e.g., one or more electrical devices coupled to the outlet 300). The power switch 330 may also be configured to reduce a voltage or current delivered to the load 360, thus providing a dimming function.

The outlet 300 may further include a power monitor 340 for measuring the consumption of power by the load 360 connected to the outlet 300. The load 360 may be connected via any suitable means, such as, e.g., standard 2 or 3 pin power outlets, 220V outlets, or international standard outlets, and may also include a wireless connection such as via a wireless charger. The power monitor 340 may transmit measured power data to the microprocessor 310 via the transceiver 320, or may also transmit data to one or more other components or devices of the system 100.

In some embodiments, the power monitor 340 also measures noise in the connection to the load 360 in order to determine the type of energy-consuming device(s) connected, e.g., as explained in U.S. application Ser. No. 13/672,534, which is incorporated herein by reference. This type of analysis is discussed, for example, in U.S. Pat. No. 8,094,034. Multiple connections throughout an entire structure may be monitored and analyzed to determine the types of devices, such as appliances, connected to define the load 360, e.g., by turning the devices on and off. In some embodiments, user activity may be inferred by monitoring a structure, e.g., identifying which loads are activated and deactivated. By monitoring power consumption characteristics at the outlet 360, characteristics of a device connected to the outlet 300 may be determined, e.g., via techniques disclosed in U.S. Pat. No. 8,094,034 or other suitable analytical methods. Based on the power consumption characteristics, the device (e.g., an oven, refrigerator; fan, or other appliance) may be beneficially and intelligently identified.

Those skilled in the art will recognize that the outlet may comprise a device that is included in a junction box or coupled to an electrical system and provides power or another utility or resource to a device. By way of example, this could be a device included in a ceiling junction box that is coupled (e.g., wired) to a ceiling fan, a device included inline to power outside flood lights, a device that monitors and/or controls the flow of natural gas to a furnace, among other variations.

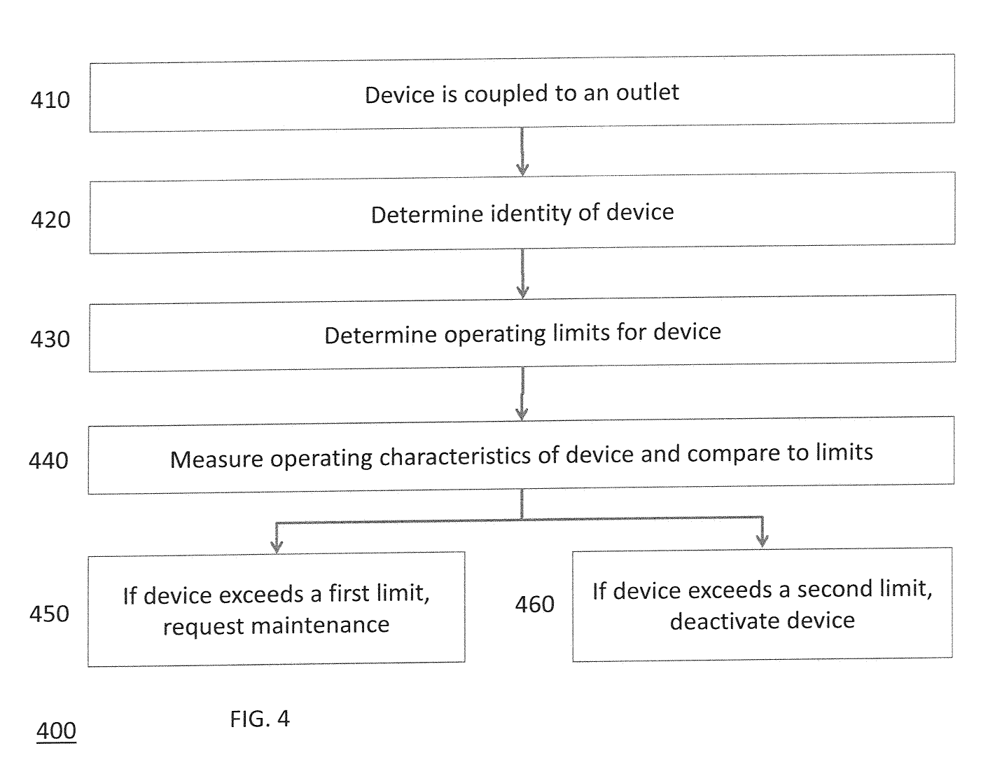

FIG. 4 illustrates an exemplary method to control power delivered to a device or appliance. In step 410; a device or appliance 180, such as, for example, a washing machine, is plugged in or otherwise connected to an outlet 130. In step 420, the outlet 130 determines an identity of the device. For example, the outlet may monitor the power delivered to the appliance 180, and based on a characteristic of the power delivered, may identify the appliance 180. The automation system 100 may exchange data, e.g., one or more messages, directly with the appliance 180, and through the message(s) may identify the appliance. The system 100 may also identify the appliance from an image captured by a camera connected to the automation system such as a sensor 370 which is part of an outlet 130. The appliance may also be manually identified by a user, such as by entering information into a database.

Outlet 130 may receive information such as the amount of power an appliance is consuming via a power monitor 340. When the appliance is plugged into or otherwise coupled to the outlet 130, the outlet 130 may track and record how much power is consumed versus time. For example, the outlet 130 may record that a washing machine consumes a first rate of power for 10 minutes, which corresponds to a wash cycle, followed by a second rate of power for 5 minutes, which corresponds to a rinse cycle, followed by a third rate of power for 5 minutes, which corresponds to a spin cycle. The data may be stored over several operating cycles, e.g., for comparison to known power consumption characteristics or patterns of a washing machine. In some embodiments, the data is transferred to a control unit (e.g., control unit 110 of FIG. 1) for comparison, in other embodiments, the data is passed to a server in the Internet cloud 140 for processing. The characteristics) or pattern of energy usage of a device therefore may be compared to known devices and identified on the basis of the most likely match, e.g., a washing machine.

Once the device is identified, one or more operating limits may be determined and retrieved from the system 100 or a database coupled to the system 100. In step 430, a component of the automation system 100 determines one or more operating limits of the identified device. The operating limits may be determined from messages or data exchanged with the device and/or from a database, which may be stored locally, such as in a component of the automation system 100. The operating limits may also be retrieved from a database connected to the Internet. The expected operating limits may include preset or static limits, or may include dynamic limits. Dynamic limits may change, for example, based on time, the age of the appliance, where the device is located, environmental conditions to which the appliance is exposed (e.g., weather, temperature, humidity, elevation, and/or amount of sun), the device's frequency of operation, and/or the number of persons in the location (e.g., the number of persons affecting or determining the device's operational load), for example. The operating limits may apply to a class of devices or appliances (e.g., washing machines), or may be tailored to a specific type or model of device or appliance (e.g., a GE Model # GFWH1200DWW 3.6 cu ft front loading washing machine). The operating limits may include expected times of operation, for example, or maximum power consumed for different time intervals. The maximum consumed power may include different limits and corresponding actions. In at least some embodiments, the operating limits are be recorded in a profile, e.g., an energy profile, associated with an identity of the device (e.g., the model of washing machine).

In step 440, one or more operating characteristics of the appliance, such as the amount of power delivered to the device, the time of day the device operates, the amount of time in operation, etc, is measured via outlet 130. The system may compare the measured operating characteristic(s) to the operating limit(s). If, for example, the device operating characteristic exceeds a first limit (step 450), the automation system 100 may determine that the appliance is working sub-optimally and that maintenance may be required. The control unit 110 may send or display a message locally and/or remotely indicating a potential problem and that maintenance may be required. The control unit 110 also may send a message to an authorized or identified provider of maintenance services, and in some embodiments may even schedule an appointment for maintenance.

As mentioned above, in some embodiments the operating limits include a maximum consumed power or a maximum power consumption rate. The maximum consumed power (or rate of consumption) may include a first limit that, when exceeded, prompts a request for maintenance (step 450). The maximum consumed power may also include a second limit that, when exceeded, prompts the system 100 to shut down the device; e.g., terminate power to the device (step 460), The limits may be dependent on other variables such as, e.g., the age of the device, environmental conditions to Which the device is exposed, and how frequently the device is operated.

During operation of a washing machine, for example, if during the spin cycle the washing machine consumes enough power to exceed a first limit associated with the device; the outlet 130 may report that the limit has been exceeded to the control unit 110. In turn, the control unit 110 may display and/or transmit a message that the washing machine needs maintenance. The message may include one or more recommendations on what to do if the limit is exceeded, e.g., recommendations such as servicing a bearing, cleaning a part, and/or contacting a service provider. In some embodiments, for example, the control unit 110 may send a warning message to a mobile device 170 indicating a need to inspect the device (e.g., washing machine) and/or schedule maintenance. In some embodiments, the control unit 110 may activate an indicator light, e.g., located on the device, an outlet connected to the device, or a control panel of the automation system, to indicate a need for inspection and/or maintenance.

If the device draws power that exceeds a second limit, as in step 460, then the outlet 130 may shut off power to the device using power switch 330, and. may send an alarm to the control unit 110. The control unit 1.10 may send a message, e.g., a warning or an alarm, to a mobile device 170 to indicate the alarm condition.

For example, the HVAC 190 of FIG. 1 may have a blower motor drawing power from breaker box 105. If the filter in the HVAC furnace is dirty, the blower may encounter additional resistance to move air and consume additional power to meet or exceed a first limit. If a bearing in the motor starts to fail, the motor may consume even more additional power as it overcomes the resistance of the failing bearing, and therefore meet or exceed the second limit. If the breaker box 105 detects that the furnace is drawing power in excess of the first limit. the breaker box 105 may send a message to the control unit 110. The control unit 110, in turn, may send a message to the home or business owner to recommend changing the filter, and the control unit 110 may also send a message online via the Internet to order replacement filters.

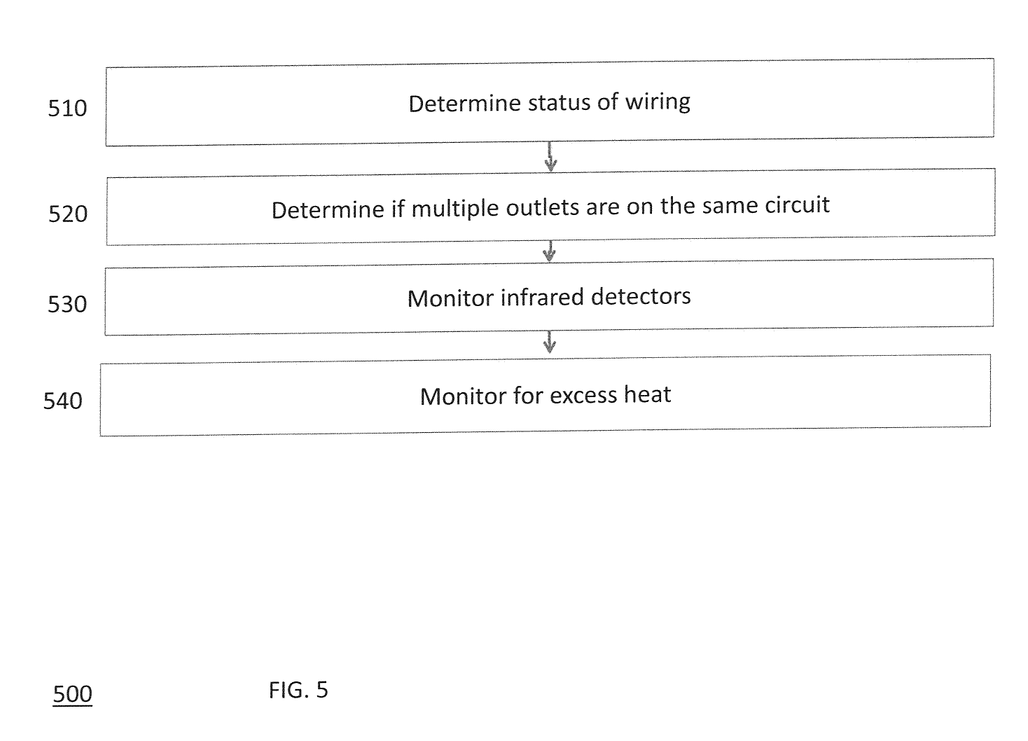

If the furnace draws power that exceeds the second limit, the breaker box 105 may disable power to the furnace and send a message to the control unit 110. The control unit 110 may notify the home or business owner that the furnace has been disabled, and also may send a message to a HVAC service provider; e.g., to schedule a maintenance appointment. When the service provider arrives, the control unit 110 may authorize the service provider to enter the building upon arrival by unlocking doors. FIG. 5 illustrates another exemplary method 500 according to the present disclosure. In step 510, the automation system 100 determines the status of wiring used to deliver power, e.g., to identify an energy loss in wires such as wires 123 or 124 in FIG. 1 potentially leading to a safety risk. For example, defective wiring may lead to inefficient power transfer and loss of energy, e.g., in the form of heat. The energy loss may be determined by measuring the voltage of wires such as wires 123 at breaker box 105 and at outlet 130. By determining the voltage drop between the measurement at breaker box 105 and outlet 130, and by knowing the amount of power supplied to the outlet 130, the resistance of the wire 123 may be determined. If the resistance changes over time, the automation system 100 may turn off power to wire 123 by opening a switch in the breaker box 105. The resistance may change, for example, if the wires corrode or become twisted or compromised, e.g., by construction or repair work. A sensor connected to automation system 100, e.g., via breaker box 105, outlet 130, or other means may also monitor the temperature of the wires.

In step 520, the automation system 100 may monitor voltage at different points to detect which devices may be connected to the same power circuit. For example, given three outlets A, B, and C (similar to outlet 300), a washing machine may be connected to outlet B. When the washing machine is turned off as determined by outlet B not measuring any power delivered to the washing machine, the voltages at A, B, C, may measure 109V, 108V, and 109V, respectively. When the washing machine is turned on, as determined by outlet B measuring power delivered to the washing machine, the voltage at A, B, and C may measure 109V, 105V, and 106V, respectively. From these measurements, the automation system may determine that outlets B and C are on the same circuit, i.e., since the voltage dropped on both outlets B and C when the washing machine turned on, whereas the voltage remained relatively constant on outlet A. The automation system may take multiple measurements with different devices in the home powered on and powered off, and use the aggregate data to determine trends of different outlets experiencing voltage drops coincident with loads activating to ascertain that outlets are likely powered by the same circuit. In addition, by monitoring the voltage and current at each node of breaker box 105, the automation system may determine which switches in the breaker box 105 are connected to which wires, or circuits, such as 123, 124, and 185.

To continue the above example, when the washing machine turns on and draws power, the outlet 130 may report that the washing machine is drawing 5 Amps. The breaker box 105 may measure the outgoing current on each node, and correlate an increase of 5 Amps to the specific circuit that is connected to outlet B. Thus, the automation system may determine which circuits are connected to which outlets without requiring a user (e.g., home owner, business owner, contractor, device or system installer, etc.) to manually enter the data.

During step 530, the automation system may monitor or collect data from infrared motion detectors connected to the automation system such as in sensor 370 as part of outlet 130, or sensor 240 which is part of switch 120, or another infrared sensor connected to system 100.

In step 540, the automation system monitors for excessive heat. Should the infrared motion detectors indicate high ambient heat, the automation system may sound an alarm, provide an indication to a user, and/or contact first responders. If levels of heat in the wires such as 123, 124, and 185 are detected, or if the loss detected in wiring changes, from a historically measured average, then the circuit may be deactivated by turning off switches that supply the circuit in breaker box 105, and by turning off power switch 330 in any outlet 130 that has been determined to be a part of the circuit. By detecting when the wiring is experiencing elevated heating and deactivating the circuit it is the goal of the invention to reduce the possibility of a fire hazard.

Certain devices such as medical or other critical devices may be attached to an outlet to draw power. The medical devices may be identified as described above regarding step 420 of FIG. 4, e.g., by the characteristics of the power drawn by the device, from messages sent between the medical. device and a device connected to the automation system 100, from noise generated by the device in the power delivery circuit, from other sensor data collected by the automation system 100 (e.g., an image), or from data entered in a user interface of a device attached to the automation system. If a medical device or other high priority device is connected to a circuit experiencing elevated heating, then the automation system may first identify any other outlets or devices that are drawing power from the same circuit. Other outlets or devices on the same circuit that are not identified as high priority may be shut off, for example, by disabling the power switch 330 in each outlet. Thus the automation system 100 may reduce the load on a circuit that is overheating without affecting electrical supply to a high priority or critical device.

Another example of a high priority device would be a freezer unit. The freezer unit may be considered critical if it is loaded with expensive frozen food in a home, for example, or if it has important medicine or biomedical samples. The freezer may share an electrical circuit with other devices, such as overhead lighting or outlets which may be used to provide power to other appliances. If the automation system detects excessive heat or current draw in the circuit, the system may disable lower priority devices, e.g., non-critical devices, such as outlets and overhead lighting while keeping power supplied to the freezer. Thus the automation system may reduce a safety hazard by reducing a load on a circuit that is overheating while maintaining power to devices that are determined to be critical.

The automation system 100 may include sail switches to detect the absence or presence of fluid and/or air flow. A sail switch may be used to monitor exhaust from a clothes dryer or other device or appliance. If the sail switch detects that airflow is restricted, for example, the automation system 100 may restrict operation of the clothes dryer, e.g., interrupt power to the device, and may contact a service provider to clean the vents. Sail switches may be used to determine that vents in different locations of a house are blocked. For example, a child may throw a winter coat over a floor heating vent of a home, preventing air from flowing and causing a room to not receive air heated or cooled by the HVAC. Sail switches may also he used to determine that proper airflow exists on the intake to a device, including a device with combustion. such as a gas-tired heater. If insufficient airflow exists on the intake, the device may not be able to burn fuel efficiently, and may increase quantities of undesirable byproducts such as carbon monoxide (CO). The automation system 100 may detect the blocked vent and issue a notification, e.g., to the owner, operator, or other user, to clear the blockage and/or to modify the operation of the HVAC system.

It is understood that the present disclosure is not limited to the particular forms, embodiments and examples illustrated. The method and apparatus of the disclosure can be practiced with and modifications and variations that do not depart from the spirit and scope of the disclosure.

Embodiments of the present disclosure may be used in connection with any structure, including, but not limited to, homes, offices, business, schools, churches, sporting complexes. In addition, at least certain aspects of the aforementioned embodiments may be combined with other aspects of the embodiments, or removed, without departing from the scope of the disclosure.

Other embodiments of the present disclosure will be apparent to those skilled in the art from consideration of the specification and practice of the embodiments disclosed herein. It is intended that the specification and examples be considered as exemplary only, with a true scope and spirit of the disclosure being indicated by the following claims.

We claim:

1. A method of controlling power to a device, the method comprising:
measuring at least one power consumption characteristic of the device;
determining an identity of the device;
comparing the at least one power consumption characteristic measured to an energy profile of the device, wherein the energy profile includes at least one operating limit and a known power consumption characteristic associated with the identity of the device; and
controlling power to the device based on the comparison.

2. The method of claim 1, wherein the identity includes a type or model of the device.

3. The method of claim 1, where the at least one operating limit is a function of time, an age of the device, an environmental condition to which the device is exposed, a frequency of operation of the device, or a combination thereof.

4. The method of claim 1, where the energy profile includes at least two limits corresponding to different operating modes of the device.

5. The method of claim 1, further comprising providing information on the status of the device based on comparison of the at least one power consumption characteristic measured and the at least one operating limit, wherein the information is stored, transmitted, displayed, or a combination thereof.

6. The method of claim 5, wherein the information includes at least one of a warning, an alarm, or a recommendation to perform maintenance on the device.

7. The method of claim 5, wherein the information is transmitted to a mobile device.

8. The method of claim 1, further comprising optimizing an energy use of the device based on the information.

9. The method of claim 1, wherein controlling power to the device includes interrupting a supply of power to the device if the at least one power consumption characteristic measured exceeds the at least one operating limit.

10. The method of claim 1, wherein the at least one operating limit includes a first operating limit and a second operating limit.

11. The method of claim 10, wherein. controlling power to the device includes interrupting a supply of power to the device if the at least one power consumption characteristic measured exceeds the second operating limit.

12. The method of claim 10, further comprising providing information on the status of the device if the at least one power consumption characteristic measured exceeds the first operating limit, the second operating limit, or both.

13. The method of claim 12, further comprising replacing the device if the at least one power consumption characteristic measured exceeds the first operating limit but not the second operating limit.

14. The method of claim 12, further comprising contacting a service provider if the at least one power consumption characteristic measured exceeds the second operating limit.

15. The method of claim 1, further comprising collecting data for the device from at least one sensor, wherein controlling power to the device is also based on the data from the at least one sensor.

16. The method of claim 15, Wherein the at least one sensor is a sail switch, a thermostat, or a thermometer.

17. A method of determining an operating condition of a device, the method comprising:
measuring at least one power consumption characteristic of the device;
determining an identity of the device;
comparing the at least one power consumption characteristic to an energy profile of the device, Wherein the energy profile includes a first operating limit, a second operating limit, and a known power consumption characteristic associated with the identity; and
providing information on the status of the device based on comparison of the at least one power consumption characteristic measured to the energy profile, wherein the information is stored, transmitted, displayed, or a combination thereof.

18. The method of claim 17, wherein the information includes at least one of a warning, an alarm, or a recommendation to perform maintenance on the device.

19. The method of claim 17, further comprising interrupting a supply of power to the device if the at least one power consumption characteristic measured exceeds the second operating limit.

20. A method of managing safety in an automation system, the method comprising:
measuring a difference in voltage between power supplied to a component of the system and power received by the component;
determining an energy loss associated with the difference in voltage; and
controlling power to the component to minimize a safety risk associated with the energy loss.

21. The method of claim 20, wherein measuring the difference in voltage includes measuring a change in voltage at a first outlet and a second outlet when an appliance connected to the first outlet or the second outlet undergoes a change of state.

22. The method of claim 21, wherein the change of state includes receiving a supply of power.

23. The method of claim 21, further including:
measuring a voltage at a breaker box connected to at least one of the first outlet and the second outlet; and
determining an energy loss in a circuit connecting the breaker box to the first outlet or the second outlet.

24. The method of claim 20, wherein the voltage measurements are repeated to determine the energy loss over time.

25. The method of claim 20, wherein the energy loss corresponds to heating of a component or wired connection of the system.

26. The method of claim 20, wherein the energy loss is measured by an infrared energy sensor.

27. The method of claim 21, further comprising determining whether the first outlet and the second outlet are on a single circuit based on the measured change in voltage.

28. The method of claim 27, wherein the first outlet and the second outlet are on a single circuit, a first device is connected to the first outlet, and a second device is connected to the second outlet, the method further comprising determining a priority between the first device and the second device.

29. The method of claim 28, wherein the energy loss corresponds to heating of the circuit, and wherein the method further comprises interrupting power to the first device or the second device based on the priority determination.

30. The method of claim 13, wherein replacing the device includes purchasing a second device.
